(19) United States
(12) Patent Application Publication
(10) Pub. No.: US 2008/0064244 A1
(43) Pub. Date: Mar. 13, 2008

(54) Plug adapter with pivotally mounted prongs

(76) Inventor: Bryan Holland, Huntington Beach, CA (US)

Correspondence Address: DARBY & DARBY P.C., P.O. BOX 770, Church Street Station, New York, NY, 10008-0770, US

(21) Appl. No.: 11/517,829

(22) Filed: Sep. 8, 2006

(51) Int. Cl. H01R 29/00

(52) U.S. Cl. 439/171

(57) ABSTRACT

Described is a plug adapter with reconfigurable prong orientation comprising a housing and an electrical plug assembly supported by the housing. The electrical plug assembly includes an adapter module, a plurality of prongs for receiving a first voltage when mated with an electrical receptacle, a converter electrically coupled to the assembly for converting the first voltage into a second voltage, and a cable electrically coupled at one end to the converter and at the other end to an electrical plug for outputting the second voltage. The prongs are pivotally mounted at a connection point on the adapter module while providing for continuous electrical contact between the prongs and the adapter module. This allows a user to effect custom placement of the adapter in the presence of obstacles or when available space is limited.

### FIELD OF THE INVENTION

The present invention relates generally to electrical plug adapters for portable electronic devices, and more particularly to electrical plug adapters having a prong assembly constructed such that the orientation of the prongs is reconfigurable.

### BACKGROUND OF THE INVENTION

A vast array of electrical and electronic devices are available for communications, personal productivity, and entertainment. These devices typically draw AC power from a wall receptacle or socket which must then be converted into one or more DC voltages before it can be used to charge or power these devices. Electrical plug adapters are the standard solution throughout the world for providing the required DC voltages to these electrical devices.

The typical work space or home office today is often cluttered with a myriad of furniture, computer equipment and peripherals, as well as other decorative or personal effects. These items, while often necessary, or at the very least pleasing to have in the work space, nevertheless can create problems with access to electrical outlets, whose placement typically does not anticipate the eventual arrangement of items in the space. This can pose a problem if it becomes necessary to plug in an adapter to recharge one of the many portable electronic devices commonly found in an office today, such as a cellular phone, a notebook computer or their associated chargers. A solution which allows the adapter to be plugged in at an orientation other than purely vertical or purely horizontal would be of great utility in the modern-day home or office.

U.S. Pat. No. 2,611,068 to Wellens discloses a pivotally mounted plug and vaporizer wherein a separate plug member comprising two prongs is pivotally connected by means of a stud to the vaporizer. The stud is held in place by means of a cotter pin, and four electrical point contacts are provided to make contact with the prongs at each of two operable positions, one horizontal and one vertical. One shortcoming of this arrangement is that continuous electrical contact is not provided as the plug member pivots about the stud. Therefore, it is not possible to customize the angle at which the device is mounted in the event that space is limited or obstructions are present.

U.S. Pat. No. 6,179,633 to Inada discloses an AC adapter having a rotating plug wherein the prongs rotate laterally by 90 degrees from a first state in which the prongs protrude from the casing and a second state in which the prongs are housed inside the casing. As in the case of Wellens above, the Inada device provides no capability for custom orientation or mounting of the device when nearby objects interfere with the desired placement location.

Another problem facing users of modern portable electronics who also travel internationally is the fact that no world standard presently exists for the delivery of electric power in various countries. Variations from one country to the next can be found in terms of delivered voltages, currents, and supply frequency characteristics, as well as the shape of the electrical prongs. Due to the fact that there is no uniform standard that applies across national boundaries for electric power delivery, it would be highly desirable to provide an electrical plug adapter that is not only portable and provides the versatility of reconfigurable prong orientation, but is also able to be used with a number of power supply systems throughout the world while accommodating the different female receptacles or outlets that will be encountered.

Conventionally, the converters within the electrical adapters are typically designed to receive a range of voltage inputs so that only a single adapter need be carried. But, in order to interface with various outlets that deliver AC power around the world, consumers typically carry a variety of input cords, each with a different type of plug. Moreover, there are commercially available electrical adapters sold for the purpose of accommodating travelers, and which are mechanical assemblies having on one end an electric plug, and on the other end, a socket accepting the standard plug interengageable with a particular country's type of receptacle. One example of this solution is the “Prong for Adapter Plug for International Use” disclosed in U.S. Pat. No. 6,109,977 to Baxter et al. The adapter plug of the '977 patent includes a set of international adapter plugs that can each be slid over the standard prongs. The standard prongs must first be rotated into a position below the surface of the face of the adapter plug before an international adapter plug can be slid into position over the standard prongs. This solution has several drawbacks, however. One such disadvantage is that the multitude of parts required for this function are very bulky and can be heavy. Furthermore, numerous parts can be easily lost in the course of travel.

Although these conventional electrical adapters permit the conversion of one type of electrical energy to another type, and fulfill their respective particular objectives and requirements, they do not provide an adapter with a reconfigurable prong orientation and interchangeable electrical plug assembly for use with a mobile phone, portable personal computer and their corresponding chargers that overcomes all of the above-mentioned drawbacks.

Consequently, it would be advantageous if a consumer could use an electrical plug adapter that can be employed in difficult or otherwise inaccessible spaces, and that can accommodate various types of electrical receptacles.

### SUMMARY OF THE INVENTION

The present invention is directed towards an electrical plug adapter with a reconfigurable prong orientation, wherein the prongs are pivotally attached to an adapter module. One embodiment of the invention provides an interchangeable module to which the prongs are pivotally attached, and which is electrically and removably connected to the adapter module. According to one embodiment, the present invention provides electrical contacts which enable continuous electrical conduction between the prongs and adapter module when the prongs are rotated about the connection point.

According to one aspect of the present invention, an electrical plug adapter is provided having a housing; an electrical plug assembly supported by the housing, the assembly including an interchangeable module coupled to an adapter module, the interchangeable module having a number of prongs for receiving a first voltage when mated with an electrical receptacle, and a converter electrically coupled to the assembly and for converting the first voltage into a second voltage.

According to another aspect of the invention, each interchangeable module has electrical prongs that are rotatable so as to enable use of the adapter in areas where access or available space is limited.

These and other objects of the present invention will become apparent to those skilled in the art from the following detailed description of the invention and embodiments, the accompanying drawings, specification, and claims.

### BRIEF DESCRIPTION OF THE DRAWINGS

FIG. 1 is a perspective view of a preferred embodiment of the electrical adapter of the present invention having an electrical plug assembly with reconfigurable prongs;

FIG. 2 is a perspective front view of an exemplary interchangeable module with rotatable electrical prongs;

FIG. 3 is a partially-exploded perspective view of a preferred embodiment of the electrical adapter of the present invention wherein the prong board is pivotally and non-removably connected at a post to the adapter module;

FIG. 4 is a top view of a preferred embodiment of the electrical adapter of the present invention;

FIG. 5 is a cross-sectional view of the prong board of the embodiment of FIG. 4;

FIG. 6 is a top view of an alternative embodiment of the electrical adapter of the present invention;

FIG. 7 is a cross-sectional view of the prong board of the embodiment of FIG. 6;

FIG. 8 is an exploded perspective front view of a second embodiment of the present invention;

FIG. 9 is an exploded perspective front view of a third embodiment of the present invention;

FIG. 10 is a perspective rear view of an exemplary interchangeable module; and

FIG. 11 is an exploded perspective view of the inner and outer housing and electrical components of the interchangeable module of FIG. 10.

### DETAILED DESCRIPTION OF A PREFERRED EMBODIMENT

The present invention generally relates to an electrical plug adapter having a reconfigurable prong orientation wherein a plurality of prongs may be disposed in a selectable direction which is convenient or expedient given the geometry of a particular space, all the while enabling proper electrical conduction between the prongs and the adapter module and providing the additional benefit of portability by being adaptable to various types of electrical plug systems used around the world.

FIG. 1 is a perspective view of the preferred embodiment of the present invention directed to an electrical adapter 10 having a housing 12, an electrical plug assembly 14 that is supported by the housing 12 and includes an input, and a converter electrically coupled to the electrical plug assembly, where the input receives an AC voltage and the converter converts the AC voltage into a different output voltage. The electrical adapter 10 includes a cable 16 supported by the housing 12 and electrically coupled to the converter. The cable 16 is coupled at one end to an electrical connector 20 for providing the output voltage to an electrical device (not shown), such as a portable computer, mobile phone or associated charger.

As shown in FIG. 1, the electrical plug assembly includes an adapter module 22 coupled to an interchangeable module 24. Interchangeable module 24 includes a plurality of prongs 26 pivotally coupled at a connection point 28 to a base 30. Prongs 26 can be any conventional prongs for use with any of a variety of standard electrical wall sockets or outlet receptacles (not shown). The plurality of prongs 26 shown in FIG. 1 is exemplary of a pair of blades conventionally used in the United States. The connection point 28 can be implemented with any structure that would be known to a person of ordinary skill in the art. One solution is to form a prong board 32 containing the prongs, which has a hole approximately centered between the prongs, the prong board then being snap-fitted to a post 34 on the base to allow pivotal rotation of the prong board 32 about post 34.

It will be understood by those of ordinary skill in the art that the electrical plug assembly 14 of FIG. 1, according to one embodiment of the present invention, is capable of accommodating the various electrical plug systems found in the world. The input part of electrical plug assembly 14 can include an interchangeable module 24 coupled with an adapter module 22. Each interchangeable module 24 is fitted with a different configuration of electrical prongs suited to a particular country, and is to be used with the adapter module to form the electrical plug assembly for the purpose of converting an electrical signal from one form to another (e.g., AC to DC). This will allow a user to selectively attach an interchangeable module appropriate to the electrical receptacles found in a particular country, while continuing to use the same adapter module.

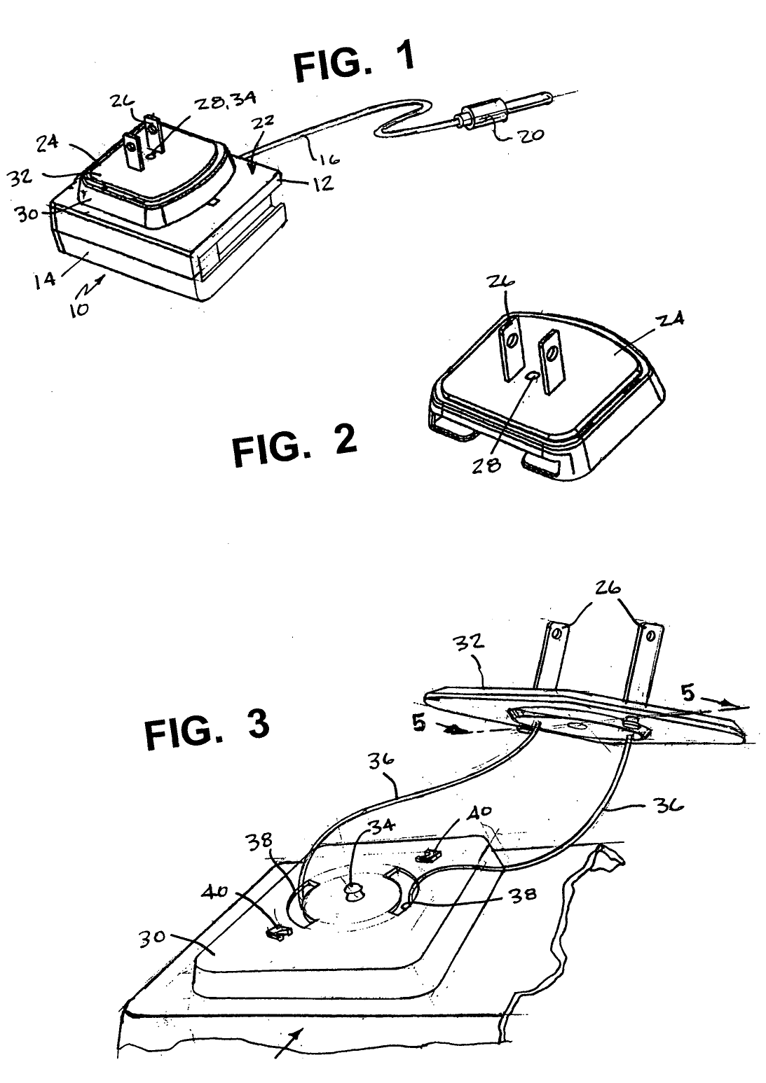

FIG. 2 shows a perspective view of an interchangeable module 24 including a pair of electrical blade contacts 26 spaced apart and supported by the interchangeable module. Connection point 28 is shown approximately centered between the blade contacts. As is conventionally known, the blade contacts 26 are inserted into the slots of an electrical receptacle for receiving AC power. In this embodiment, blade contacts 26 are suitable for use with receptacles found in the United States.

In one embodiment, the present invention provides for continuous electrical contact between the pivotally mounted adapter prongs and the adapter module while the prongs are being rotated about the connection point. Alternatively, electrical contact may be provided only at the two end-points of rotation, and/or a limited number of intermediate points. The mode of electrical contact can take several forms. In FIG. 3, an embodiment is shown wherein the prong board 32 is pivotally and non-removably connected at post 34 to the adapter module and electrical contact is provided through wires 36 connected to the prongs at one end and the converter at the other end, the wires 36 being disposed through two arc-shaped slots 38 opposed about the connection point. To prevent the wires from becoming wound or entwined with one another, the movement of the base can be restricted to an arc approximately in the range of 90 to 180 degrees by the use of small, raised stops 40, or the like, on the adapter module that would interfere with corresponding stops on the prong board 32, thereby restricting rotation of the prong board. More preferably, the raised stops may be fashioned or molded such that locking action is possible at either end of the arc. That is, at each end further rotation would be blocked, while a small amount of additional urging would cause the base to become locked when a first stop is overcome and a second, possibly larger stop is encountered, thereby locking the base in position, at either end of rotation.

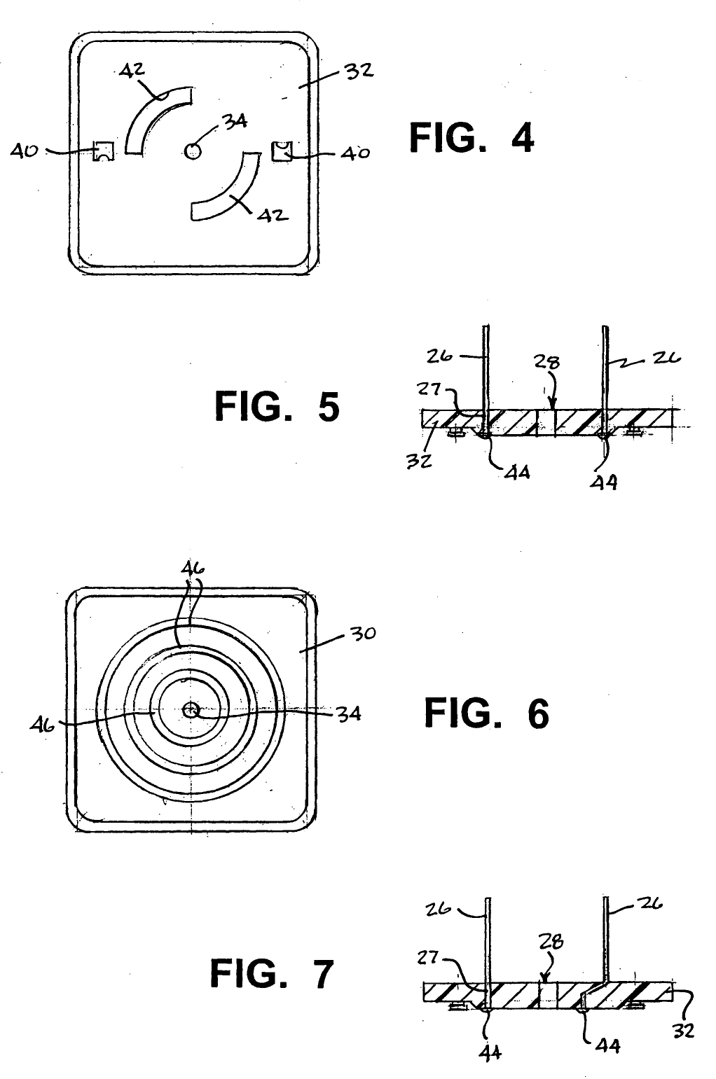

A further embodiment that provides continuous electrical conduction while pivoting the prongs is illustrated in FIGS. 4-5. Two arc-shaped electrical contacts 42 are provided, opposed about the post 34 on the base 30, having flat top surfaces for making contact with prong contacts 44 provided on the rotatable prong board 32. The flat top surfaces of the contacts may be disposed at or slightly above the level of the base casing, or may be recessed inside sunken arc-shaped holes or slots. The prong contacts on the base have a height appropriate to provide continuous electrical contact with the contact on the adapter module while also avoiding excessive friction forces that would impede rotation of the base. Small, raised stops 40 may be used to limit rotation of the base to the zone containing the arc-shaped contacts. FIG. 5 shows a cross-sectional view of a preferred arrangement of prongs 26, leads 27 and prong contacts 44 on the prong board 32, as well as the connection point 28.

Another embodiment of the present invention wherein continuous electrical contact is maintained while pivoting the prongs is illustrated in FIGS. 6-7, wherein the base electrical contacts take the form of a plurality of concentric circles 46 on the base 30, centered about the post 34. This configuration allows 360-degree rotation of the prongs about the connection point. FIG. 7 shows a cross-sectional view of the prong board 32 and attached prongs 26 with the arrangement of the leads 27 and contacts required for the individual prong contacts 44 to make electrical contact with their respective base contacts 46. As shown in FIG. 7, the prongs 26 are shifted in a radial direction as they go through the prong board 32 in order to be radially positioned to the corresponding concentric circle 46 for each prong 26.

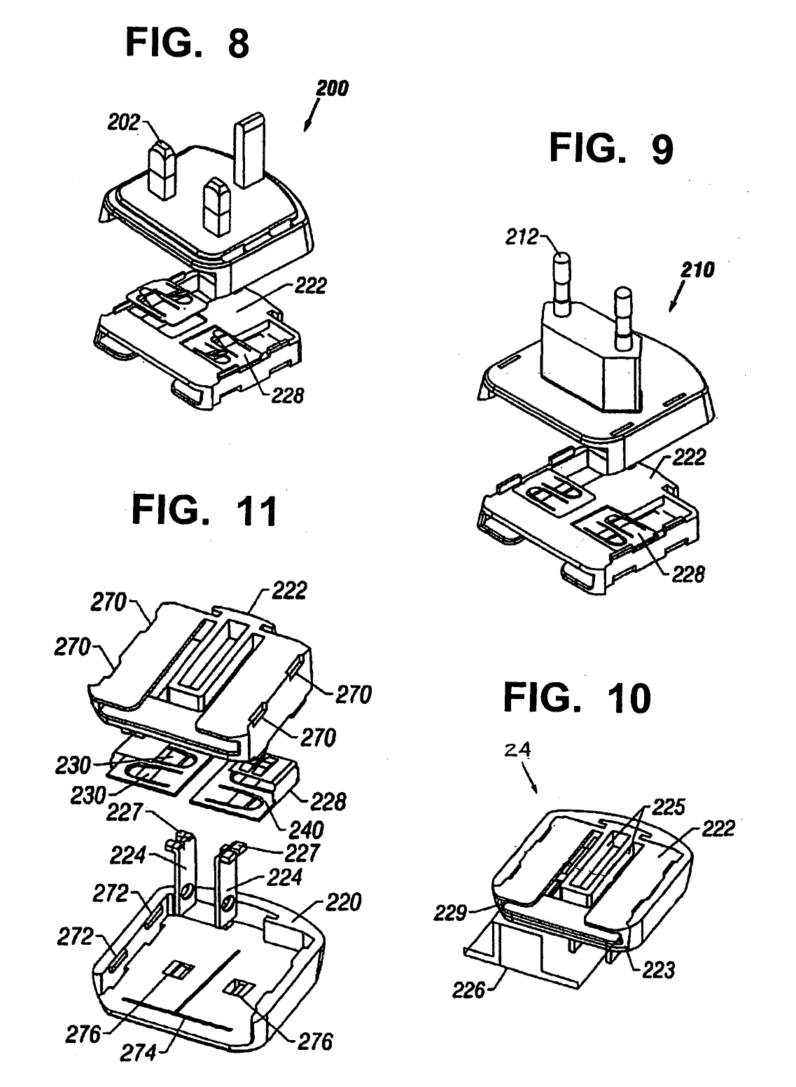

Alternative embodiments of the present invention provide for interchangeable modules that are configured to operate with electrical plug systems used by other countries. For example, FIG. 8 shows an exploded perspective view of an interchangeable module 200 configured with three electrical prongs 202 of the type used in the United Kingdom. FIG. 9 shows an exploded perspective view of an interchangeable module 210 configured with two electrical prongs 212 of the type used in Germany.

It will be appreciated by those skilled in the art that the interchangeable modules shown in the embodiments of FIGS. 2, 8 and 9 employ a similar construction. Referring to a perspective rear view of the interchangeable module 24 in FIG. 10, the interchangeable module 24 preferably includes a body (e.g., casing) formed by two parts, although other conventional ways in which to fabricate a single integral casing may be used. When two parts are used, they include an outer housing 220 which receives an inner housing 222 (shown partially cut-away). Both the inner and outer housings 222, 220 are preferably formed from a nonconductive material, that is both an electrical and thermal insulator. A thermally resistive housing for the interchangeable module 24 assists a user in safely handling the module with its electrical conducting components supported therein. When assembled, module 24 shields a user from coming into direct contact with the components that conduct electrical energy that are disposed within module 24.

There are a number of ways that the inner housing may be assembled with the outer housing upon final fabrication. For example, as shown in the exploded perspective view of FIG. 11, a portion of inner housing 222 includes indentations 270 therein. Although only shown from one side of the housing 222, these indentations 270 are also symmetrically disposed on an opposite side of the inner housing 222. The indentations are preferably punched through the inner housing during the fabrication process. The outer housing 220 includes pairs of pressure-loadable hooks 272 extending therefrom and symmetrically disposed on two sides of the housing 220. When inner housing 222 and outer housing 220 are assembled together, the hooks 272 are snap-fitted into indentations 270 to thereby secure inner housing 222 within outer housing 220, and to form the body of the interchangeable module 24. Alternatively, outer housing 220 may include built-in ribs 274 which may be welded (e.g., using an ultrasonic weld) to an opposite surface (not shown) located on inner housing 222 when assembled together. This arrangement ensures a more reliable and firmly supported interchangeable module 24 including inner housing 222 and outer housing 220. It will be recognized by those of ordinary skill in the art that alternative methods of securing housings 220 and 222 together include the use of bonding agents, epoxy agents and solvents, so long as such use is consistent with the principles disclosed herein.

Referring back to FIG. 10, the rear side of inner housing 222 includes symmetrically disposed gaps 225 which facilitate the matching of the interchangeable module to the adapter module. Gaps 225 are preferably fabricated to a sufficient width (e.g., 3 mm) that allow the mating portion of the adapter module to be slidably received therewith, but provides a safety feature in preventing fingers and other objects from passing therethrough to touch components conducting electricity.

When the interchangeable module 24 coupled to the adapter module 22 is plugged into an electrical receptacle outlet (not shown), AC power is drawn from the outlet and received through prongs 224, which are in electrical contact with spring contact 228 and bus bars 336. The AC power is typically a high voltage (e.g., 110/220 VAC) and is referred to herein as the “high voltage.” By contrast, the electrical device (e.g., mobile phone, notebook computer or their corresponding chargers) being powered by the electrical adapter of the present invention typically requires a DC voltage of, for example, 5 volts, and is referred to herein as the “low voltage”. Accordingly, an AC-to-DC converter is used to convert the high voltage to the low voltage.

It will be appreciated by those of ordinary skill in the art that a number of conventional AC-to-DC converters may be utilized to perform this conversion.

The foregoing detailed description of the invention has been provided for the purposes of illustration and description. Although exemplary embodiments of the present invention have been described in detail herein with reference to the accompanying drawings, it is to be understood that the invention is not limited to the precise embodiments disclosed, and that various changes and modifications to the present invention are possible in light of the above teaching.

1. A plug adapter with reconfigurable prong orientation, comprising:
a housing; and
an electrical plug assembly supported by said housing, said assembly including:
an adapter module;
a plurality of prongs for receiving a first voltage when mated with an electrical receptacle, wherein said prongs are pivotally mounted about a connection point on the adapter module wherein the prongs are movable between a first position and second position and providing electrical contact between the prongs and the adapter module in both first and second positions; and
a plurality of wires connecting the prongs and the adapter module wherein continuous electrical contact is provided between the prongs and the adapter module.

2. (canceled)

3. The plug adapter of claim 1, and wherein the rotation of the prongs is limited to an arc of approximately 180 degrees or less.

4-7. (canceled)

8. The plug adapter of claim 1, wherein the plurality of wires is disposed between arc-shaped slots.
